(19) United States
(12) Patent Application Publication
(10) Pub. No.: US 2009/0205506 A1
(43) Pub. Date: Aug. 20, 2009

(54) BOTTLE CAP HAVING FILLING FUNCTION

(76) Inventor: Sheng-Chi LIN, Taipei City (TW)

Correspondence Address: HDLS Patent & Trademark Services, P.O. BOX 220746, CHANTILLY, VA, 20153-0746, US

(21) Appl. No.: 12/031,134

(22) Filed: Feb. 14, 2008

(51) Int. Cl. A47J 31/44; B65D 41/38

(52) U.S. Cl. 99/323; 215/329; 215/250

(57) ABSTRACT

A bottle cap having a filling function for an object to be brewed is interconnected to a container's spout, including an outer cover cap and an inner sleeve, in which the outer cover cap has a top plate, an outer ring body and an inner ring body, both of which are extended from the top plate, and between which a spacing room is formed. According to the invention, the inner sleeve is fitted to an outer circumferential edge of the inner ring body, such that a storage room for storing an object to be brewed is formed between the inner ring body and the inner sleeve having a bended edge abutted against a side face of the spout. In addition, a sectional trough is arranged at one side far away the bended edge of the inner sleeve. Thereby, when the outer cover cap moves toward the container, the storage room will be opened to make the object to be brewed automatically filled into the container.

### BACKGROUND OF THE INVENTION

1. Field of the Invention

The present invention generally relates to a bottle cap, in particular, to a bottle cap having a filling function.

2. Description of Prior Art

Basically, a bottle cap having storage room can separately store an object to be brewed and a solution before blending them together to make a drink. Under such structural arrangement, the drink's freshness can be maintained and the expiration date can be prolonged.

According to prior arts, a bottle cap having storage room includes an outer cover cap and a top cap, in which an interior of the outer cover cap has a storage room, which is for storing an object to be brewed, and a bottom part of which is sealed by a sealing membrane. In this case, the top cap screwed above the outer cover cap is internally abutted by a top pillar. When using, the top cap is rotated to move down the top pillar that is then abutted against the sealing membrane. After the sealing membrane is opened, an object to be brewed that is filled in the storage room will be slid down and mixed with the solution in the container.

However, this kind of bottle cap has following drawbacks:

Firstly, since the outer cover cap is inter-screwed with the top cap, the top cap is easily loosened to cause a leakage of the object to be brewed when any vibration is occurred in a transporting process. More seriously, the top cap will be moved down to make the top pillar open the sealing membrane to mix the object to be brewed with the solution.

Secondly, since the sealing membrane is arranged under the storage room by a pasting method, the membrane is easily dropped into the solution entirely when the cap pillar is abutted the sealing membrane downwardly.

Thirdly, since the sealing membrane is sealed by a pasting method, it is impossible to reuse the bottle cap having storage room according to the prior arts. If a reuse is needed, the user has to prepare a totally new sealing membrane for a sealing purpose.

According to another prior art of a bottle cap having storage room, a ringed blade is arranged under the storage room. When the outer cover cap is rotated, the sealing membrane arranged at the bottom part will move downwardly and contact with the ringed blade, such that a function of opening the sealing membrane is achieved. Furthermore, a stopper is arranged at an outside of the outer cover cap. The stopper is torn off, when the object to be brewed is going to be mixed with the solution. In such arrangement, it can prevent the object to be brewed from being mixed with the solution if caused by any vibration occurred in a transporting process.

However, there are many problems that still can not be solved by this kind of bottle cap having storage room, for example: 1) the sealing membrane could be dropped into the solution; 2) it is unable to be reused; and, 3) it is a little dangerous to use a structure like s ringed blade.

Accordingly, aiming to solving the aforementioned shortcomings, after a substantially devoted study, in cooperation with the application of relatively academic principles, the inventor has at last proposed the present invention that is designed reasonably to possess the capability to improve the prior arts significantly.

### SUMMARY OF THE INVENTION

The invention is mainly to provide a bottle cap having a filling function for an object to be brewed and interconnected to a container's spout. According to the invention, by means of a bended edge arranged at an inner sleeve, a storage room will be opened to make the object to be brewed automatically filled into the container when an outer cover cap is moved toward the container.

Secondly, the invention is to provide a bottle cap having a filling function for an object to be brewed and interconnected to a container's spout. According to the invention, the object to be brewed that is stored in a storage room is separated from a solution contained in the container, both of which can be blended when a drink is needed to make. Under such arrangement, a freshness of the drink may be maintained.

Thirdly, the invention is to further provide a bottle cap having a filling function. According to the invention, by means of a structure of bended edge and sectional trough, the bottle cap may be reused to achieve a double benefit of cost saving and environmental protection.

In summarization, the invention is to provide a bottle cap having a filling function for an object to be brewed and interconnected to a container's spout. The bottle cap according to the invention includes an outer cover cap and an inner sleeve, in which the outer cover cap has a top plate, an outer ring body and an inner ring body, both of which are extended from the top plate, and between which a spacing room is formed. Furthermore, the inner sleeve is partially accommodated in the spacing room and is fitted to an outer circumferential edge of the inner ring body, such that a storage room for storing an object to be brewed is formed between the inner ring body and the inner sleeve having a bended edge abutted against a side face of the spout. In addition, a sectional trough is arranged at one side of the inner sleeve far away the bended edge.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is an explosively perspective view according to the present invention;

FIG. 2 is an explosively sectional view according to the present invention;

FIG. 3 is an explosively sectional view according to a preferable embodiment of the present invention;

FIG. 4 is a sectional assembled view according to a preferable embodiment of the present invention;

FIG. 5 is a first illustration showing a using status according to a preferable embodiment of the present invention; and

FIG. 6 is a second illustration showing a using status according to a preferable embodiment of the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

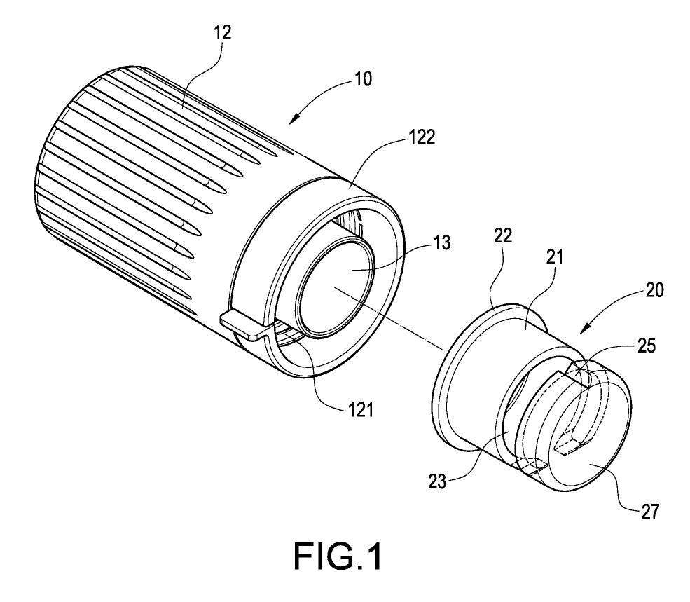

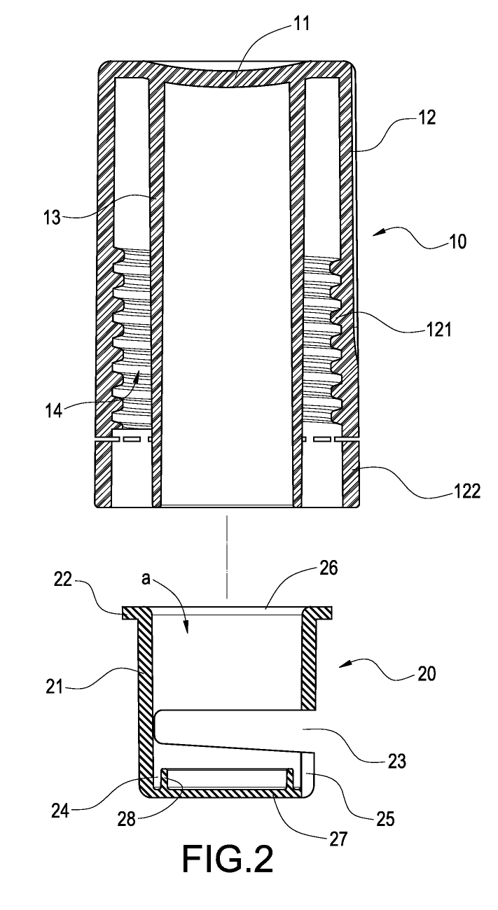

Please refer to FIG. 1 and FIG. 2, which respectively are an explosively perspective view and an explosively sectional view according to the present invention. Basically, the invention is interconnected to a container's spout (not shown in the figure) to provide a filling function for an object to be brewed, for example, tea leaf, coffee powder, and milk powder. The bottle cap includes an outer cover cap 10 and an inner sleeve 20.

The outer cover cap 10 has a top plate 11, an outer ring body 12 and an inner ring body 13, both of which are extended from the top plate 11, and between which a spacing room 14 is formed. In addition, an internal thread 121 is arranged on an inner wall of the outer ring body 12, while a stop ring 122 that can be torn off is arranged at one side of the outer ring body 12 far away the top plate 11.

In this case, the inner sleeve 20 having a tube pillar 21 is partially accommodated in the spacing room 14 and is fitted to an outer circumferential edge of the inner ring body 13. In the meantime, a storage room “a” for storing the object to be brewed (not shown in the figure) is formed in an interior between the inner ring body 13 and the tube pillar 21. The tube pillar 21 has an opening 26, from an outer circumferential edge of which a bended edge 22 is extended outwardly. Furthermore, a sectional trough 23 that is a radial slot is arranged at one side of the inner sleeve 20 far away the bended edge 22. Meanwhile, a sealing plate 27 is also arranged at one side of the tube pillar 21 far away the opening 26. Restated, the sectional trough 23 is arranged between the opening 26 and the sealing plate 27 in a radial direction. Also, an axial trough 25 is arranged on an outer surface of the tube pillar 21 between the sectional trough 23 and the sealing plate 27. In an interior of the sealing plate 27, a positioning ring 28 is projected, and a securing trough 24 is formed between the positioning ring 28 and the tube pillar 21 for being able to be snapped into and connected to the inner ring body 13.

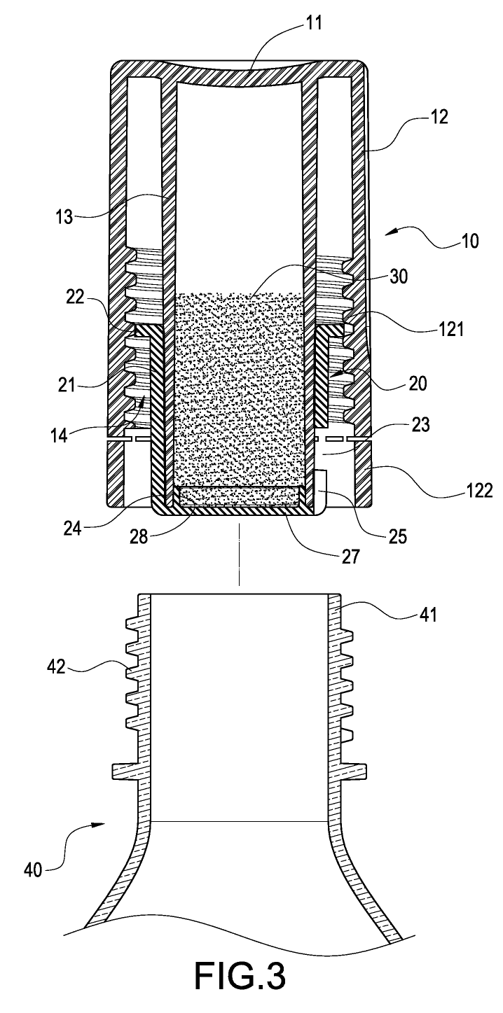

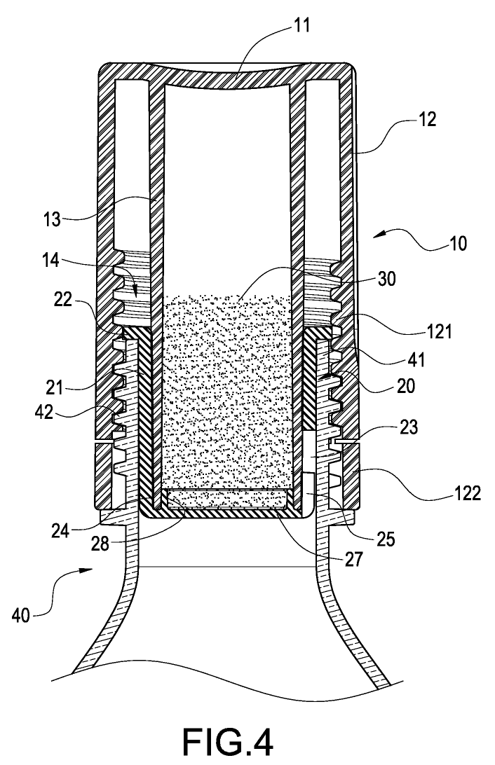

Please refer to FIG. 3 and FIG. 4, which respectively are an explosively sectional view and an assembled sectional view according to a preferable embodiment of the present invention. In an assembling procedure, an object to be brewed is firstly placed into the inner ring body 13; then, the inner sleeve 20 is snapped into the outer cover cap 10; thirdly, an external thread 42 formed at an outer circumferential edge of the bottle spout 41 is inter-screwed with the internal thread 121; fourthly, a bottom part of the inner ring body 13 is abutted to the securing trough 24 of the inner sleeve 20, making the storage room 1 shown as a sealing status to store the object to be brewed 30; finally, the bended edge 22 is abutted to the bottle spout 41 for securing the inner sleeve 20.

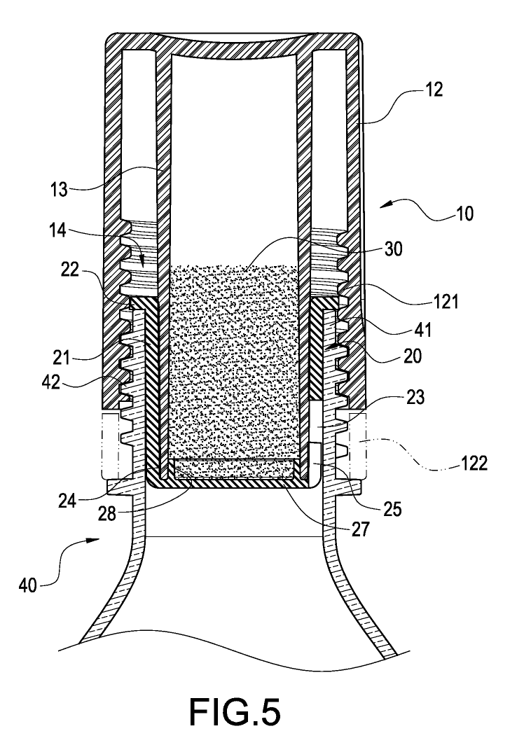

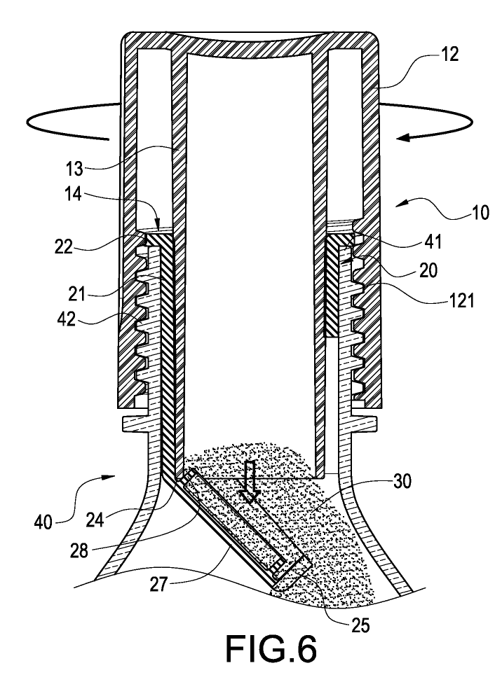

Please refer to FIG. 5 and FIG. 6, which respectively are a first illustration and a second illustration that show using statuses of a preferable embodiment according to the present invention. When the invention is going to be used, the stop ring 122 is firstly torn off, and then the outer cover cap 10 is rotated to be moved downwardly. When the outer cover cap 10 is moved downwardly, the inner ring body 13 will be abutted to a bottom part of the securing trough 24. When the outer cover cap 10 is moved downwardly continuously, a bottom part of the inner sleeve 20 is further squeezed and pressed, making the bottom part of the inner sleeve 20 opened from the sectional trough 23. Finally, the storage room a is opened, making the object to be brewed that is stored therein dropped into the container 40 and mixed with a solution (not shown in the figure) stored therein. In addition, when the sealing plate 27 is squeezed to be pressed and deformed, the axial trough 25 can provide a buffering room, making the bottom part of the inner sleeve 20 opened smoothly.

Therefore, the bottle cap having filling function according to the present invention has following merits:

1. Since the inner sleeve 20 is applied for separating the object to be brewed 30 from the solution, both of which will be then mixed when a drink is needed to be mixed, so a freshness of the drink may be ensured.

2. By means of the sectional trough 23 designed for the inner sleeve 20, the bottle cap is capable to refill the object to be brewed 30. Thereby, the bottle cap can be reused to achieve a double benefit of cost saving and environmental protection.

3. When the storage room a is opened, the sealing plate 27 being dropped into the container and mixed with the stored solution won't happen, so it is more conformable to a sanitary requirement.

Summarizing aforementioned description, the invention is a novel structure of bottle cap indeed, which may positively reach the expected usage objective for solving the drawbacks of the prior arts, and which extremely possesses the innovation and progressiveness to completely fulfill the applying merits of new type patent, according to which the invention is thereby applied. Please examine the application carefully and grant it as a formal patent for protecting the rights of the inventor.

Moreover, the aforementioned description is only a preferable embodiment according to the present invention, being not used to limit the patent scope of the invention, so equivalently structural variation made to the contents of the present invention, for example, description and drawings, is all covered by the claims claimed thereinafter.

What is claimed is:

1. A bottle cap having a filling function for an object to be brewed and interconnected to a container's spout, including:
an outer cover cap, which has a top plate, an outer ring body and an inner ring body being extended from the top plate, and between which a spacing room is formed; and
an inner sleeve, which is fitted to an outer circumferential edge of the inner ring body, such that a storage room for storing an object to be brewed is formed between the inner ring body and the inner sleeve, the inner sleeve having a bended edge abutted against a side face of the spout, in addition, a sectional trough being arranged at one side far away the bended edge of the inner sleeve;
when the outer cover cap moves toward the container, the storage room is opened to make the object to be brewed automatically filled into the container.

2. The bottle cap having a filling function according to claim 1, wherein an internal thread is formed on an inner wall of the outer ring body, and an external thread is formed at an outer conferential edge of the spout and is inter-screwed and connected to the internal thread.

3. The bottle cap having a filling function according to claim 1, wherein a stop ring is arranged at one side of the outer ring body far away the outer top plate and is torn off when a drink is needed to be made.

4. The bottle cap having a filling function according to claim 1, wherein the inner sleeve has a tube pillar having an opening, from an outer circumferential edge of which the bended edge is extended outwardly.

5. The bottle cap having a filling function according to claim 4, wherein a sealing plate is arranged at one side of the tube pillar far away the opening, and wherein the sectional trough is arranged between the opening and the sealing plate in a radial direction.

6. The bottle cap having a filling function according to claim 5, wherein an axial trough is arranged on an outer surface of the tube pillar between the sectional trough and the sealing plate.

7. The bottle cap having a filling function according to claim 5, wherein a positioning ring is arranged in the sealing plate with a projective way, and a securing trough is formed between the positioning ring and the tube pillar, and capable to be applied for the inner ring body to be snapped therein and connected thereto.
